(19) United States
(12) Patent Application Publication
(10) Pub. No.: US 2019/0144726 A1
(43) Pub. Date: May 16, 2019

(54) THERMALLY STABLE SILOXANE-BASED PROTECTION FILM

(71) Applicant: 3M INNOVATIVE PROPERTIES COMPANY, St. Paul, MN (US)

(72) Inventors: Guannan Yin, Shanghai (CN); Audrey A. Sherman, Woodbury, MN (US); Kevin R. Schaffer, Woodbury, MN (US); Zachary S. Erdman, Prior Lake, MN (US); Moses M. David, Woodbury, MN (US)

(21) Appl. No.: 16/186,028

(22) PCT Filed: May 13, 2016
(86) PCT No.: PCT/CN2016/082013

§ 371 Date: Nov. 9, 2018

(51) Int. Cl. C09J 183/10; C09J 7/50; G02B 1/14

(52) U.S. Cl. CPC C09J 183/10; C08G 77/455; G02B 1/14; C09J 7/50

(57) ABSTRACT

Protective film articles include a thermally stable tape backing with a first major surface and a second major surface, a primer layer on the first major surface of the thermally stable tape backing, and a self-wetting, tack-free adhesive layer at least partially coated on the primer layer. The tack-free adhesive layer includes at least one siloxane-based elastomeric polymer that is thermally stable, and is able to removably adhere to an optical or electronic device without leaving residue on the optical or electronic device. The protective film articles can be used in the preparation of a wide range of optical and electronic articles.

### FIELD OF THE DISCLOSURE

The present disclosure relates generally to the field of protective film articles, specifically to the field of protective film articles useful as processing tapes in the preparation of optical and electronic articles.

### BACKGROUND

Protective film articles are widely used in the optical and electronics industries. Protective film articles are articles that are applied to protect a surface for a limited period of time and are then removed before the optical or electronic article is used. A wide range of protective film articles are used, for a wide range of purposes. For example, when articles are shipped they often have a protective film articles to protect exposed surfaces. These protective films run the gamut from films that protect the surface of an automobile during shipping to protecting the screen of a computer, smart phone, or tablet device. In addition to protective films that protect surfaces during shipping, a wide range of protective film articles are used to protect surfaces during processing steps. These protective film articles are sometimes referred to as “processing tapes”. Unlike those articles that protect surfaces during shipping, the processing tapes can be exposed to a wide range of conditions including high temperatures, mechanical contact such as applied pressure or mechanical abrasion, and a variety of other extreme conditions.

Despite the range of uses for protective films, they all have certain properties in common. Among these features are that they comprise a film substrate with a surface that adheres to the surface to be protected and remains adhered until removed, and upon removal leaves behind no residue.

The adhering surface can be cling surface such as in SARAN wrap, or in electrostatically charged cling surfaces, or it may be an adhesive surface. When the protective article includes a film substrate that is a tape backing and an adhesive layer the article is generally referred to as a “tape”.

Among the types of adhesives commonly used are pressure sensitive adhesives. Pressure sensitive adhesives are well known to one of ordinary skill in the art to possess certain properties at room temperature including the following: (1) aggressive and permanent tack at room temperature, (2) adherence with no more than finger pressure, (3) sufficient ability to hold onto an adherend, and (4) sufficient cohesive strength to be removed cleanly from the adherend. Materials that have been found to function well as pressure sensitive adhesives are polymers designed and formulated to exhibit the requisite viscoelastic properties resulting in a desired balance of tack, peel adhesion, and shear strength. The most commonly used polymers for preparation of pressure sensitive adhesives are natural rubber, synthetic rubbers (e.g., styrene/butadiene copolymers (SBR) and styrene/isoprene/styrene (SIS) block copolymers), various (meth)acrylate (e.g., acrylate and methacrylate) copolymers and silicones. Each of these classes of materials has advantages and disadvantages.

Pressure sensitive adhesive tapes that are used in the manufacture of articles to protect or temporarily hold in place components of the article during processing are sometimes called processing tapes. Examples of processing tapes include, for example, wafer dicing tapes, where the dicing tape may also function as a die attach adhesive for dicing thinned wafers and subsequent die attach operations of the diced chips in semiconductor device fabrication. Another example of a processing tape is a masking tape, where the masking tape is applied to a surface to cover it and protect it from being painted, the paint is applied, and the masking tape is removed to give a surface with adjacent areas that are painted and unpainted. Typically the processing tape is not retained in the final article, but is removed following one or more processing steps. In some instances, processing tapes are subjected to extreme conditions such as high temperatures, high pressures, exposure to chemicals such as solvents, abrasives, etching materials, and the like and yet are expected to remain adhered during the processing steps without flowing, dripping or slipping and also to be removable after the processing steps are completed.

### SUMMARY

Disclosed herein are protective film articles and methods of using protective film articles. The protective film article comprise a thermally stable tape backing with a first major surface and a second major surface, a primer layer on the first major surface of the thermally stable tape backing, and a self-wetting, tack-free adhesive layer at least partially coated on the primer layer. The tack-free adhesive layer comprises at least one siloxane-based elastomeric polymer that is unchanged after heat aging of 180° C. for 30 minutes, and is able to removably adhere to an optical or electronic device without leaving residue on the optical or electronic device.

Also disclosed are methods of preparing an optical or electronic comprising providing an optical or electronic construction comprising where the optical or electronic construction comprises a first major surface and a second major surface, providing a protective film article with a tack-free adhesive layer, adhering the tack-free adhesive layer of the protective film article to the second major surface of the optical or electronic construction to form a laminate, subjecting the optical laminate to at least one processing step, and cleanly removing the protective film article from the second major surface of the optical or electronic construction. The protective film article is described above and comprises a thermally stable tape backing with a first major surface and a second major surface, a primer layer on the first major surface of the thermally stable tape backing, and a self-wetting, tack-free adhesive layer at least partially coated on the primer layer. The tack-free adhesive layer comprises at least one siloxane-based elastomeric polymer that is unchanged after heat aging of 180° C. for 30 minutes, and is able to removably adhere to an optical or electronic device without leaving residue on the optical or electronic device. The laminate constructions can be subjected to a wide variety of processing steps.

### DETAILED DESCRIPTION

The use of adhesive tapes is increasing. Among the areas in which the use of adhesive tapes is increasing are the medical, electronic and optical industries, as well as the manufacture of consumer goods and other articles, including security documents. The requirements of these industries require adhesive tapes with specialized features. For example, adhesive tapes are needed that provide additional features beyond the traditional tape properties of tack, peel adhesion and shear strength.

Among the class of adhesive tapes that require specialized properties are protective film articles. Protective film articles are ones that are intended to adhere to a surface of an article only for a temporary period and then are removed prior to the article being used. Examples of protective film articles are shipping tapes and films and processing tapes. Processing tapes are adhesive tapes that are used in the manufacture of articles to protect or temporarily hold in place components of the article during processing. Examples of processing tapes are described above.

The protective film articles of this disclosure are suitable for use in the preparation of optical articles and therefore function as processing tapes. The terms “protective film article” and “processing tape” are used interchangeably in this disclosure.

The protective film articles of the present disclosure have a thermally stable backing with a plasma-coated discontinuous silane-based primer layer on a surface of the thermally stable backing, and a self-wetting, tack-free adhesive layer in contact with the plasma-coated discontinuous silane-based primer layer. The protective film article functions as a processing tape designed to protect a surface through a series of processing steps and is then removed. Upon removal, the surface that was protected is restored to its original properties. In other words, adhering and removing the processing tape does not alter or damage the surface to which it is adhered. These concepts and the materials used to provide the desired features are described in greater detail below.

The processing tapes of this disclosure have a broad range of desired properties, some of which are contradictory properties. For example, since, as will be described more thoroughly below, it is desirable that the adhesive layer of the tape be self-wetting, that is that it wets out the surface to which it is applied without the application of pressure, it is desirable that the adhesive be soft and conformable. However, soft and conformable adhesives are not desirable for other processing steps. For example, soft and conformable adhesive layers are likely to flow or ooze when subjected to elevated temperatures and pressures, which is undesirable or even unacceptable in many applications. Additionally, as the surfaces that the processing tape is designed to protect are optical or electronic surfaces, if the adhesive layer flows on the surface, upon removal of the adhesive layer it is likely for portions of the adhesive layer (adhesive residue) to be left on the nanostructured surface. This is undesirable and often unacceptable. Thus the adhesive layer has to adhere strongly enough to the article surface to remain in place and protect the surface, but it must not adhere so strongly that it leaves residue on the surface.

Among the properties desired for the adhesives of the processing tapes of this disclosure, are non-tackiness, self-wetting (rapid wetting out of substrate surfaces), and thermal stability.

The adhesive layers of the processing tapes of the present disclosure are “tack-free adhesives”. The properties of these tack-free adhesives are defined below, but generally it means that the adhesive layers are viscoelastic materials with properties similar to those of pressure sensitive adhesives, but they lack the permanent and aggressive tack at room temperature that are characteristic of pressure sensitive adhesives. Despite the lack of tackiness, the adhesive layers are self-wetting. However, as will be shown in the Examples section, film layers that are non-tacky do adhere strongly enough to provide protection for the desired surface.

Also desirable for the processing tapes of the present disclosure are adhesives with useful wet out properties. Specifically, the ability to sufficiently wet out the surface to which it is applied, such that the adhesive layer adheres quickly and remains adhered to the surface during a series of processing steps, including processing steps involving the application of heat and/or pressure, and to remain removable without leaving residue. Thus the adhesive layer has a balance of properties such that it adheres to the desired surface but not so strongly as to leave residue.

Thermal stability is another important property of the adhesive layers of the processing tapes of the present disclosure. In this context thermal stability refers not only to the ability of the adhesive to be subjected to elevated temperatures without undergoing chemical changes, but also to the ability to withstand elevated temperature processes without flowing, oozing or becoming non-removable from the nanostructured surface to which it is adhered. Examples of chemical changes that polymeric materials such as the adhesive layers of the present disclosure could undergo upon exposure to elevated temperatures include: degradation, including complete de-polymerization as well as small amounts of chain scission (degradation is undesirable in this application as it is likely to lead to the leaving of residue on the nanostructured surface); and hardening, in which further polymerization occurs (hardening is undesirable in this application as it is likely to lead to either the inability to remove the adhesive layer from the nanostructured surface or to such strong adhesion to the nanostructured surface that damage occurs upon removal). In this application, thermal stability is typically referred to as the adhesive layer remaining unchanged after heat aging.

It should be noted that thermal stability is a materials property of the adhesive layer, and is not a processing step. Thus when an adhesive layer is said to be unchanged after heat aging of 180° C. for 30 minutes, it means that the adhesive layer has that property, and is capable of undergoing that heat aging without physical or chemical changes, and it does not mean that the adhesive layer has been subjected to such heat aging or that the adhesive layer will be subjected to such heat aging in the future. This heat aging property is similar to the way in which other adhesive properties are presented. For example, when an adhesive layer is said to have a 180° Peel Adhesion to glass of 20 Newtons/decimeter, that is a material property of the adhesive, and does not in any way mean that the adhesive in question must be adhered to a glass substrate. Rather, this test procedure is established to provide a reference value for a measurable quantity, in this case adhesion to glass. Thus the thermal stability of the adhesive layers of this disclosure have the feature of being unchanged after heat aging of 180° C. for 30 minutes, but this is a processing limitation it is a quantification of the material property of thermal stability.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “adhesive” as used herein refers to polymeric compositions useful to adhere together two adherends. Examples of adhesives are pressure sensitive adhesives and low tack adhesives.

Pressure sensitive adhesive compositions are well known to those of ordinary skill in the art to possess properties including the following: (1) aggressive and permanent tack at room temperature, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “tack-free adhesive” as used herein refers to an adhesive composition that is a viscoelastic material that is similar to a pressure sensitive adhesive composition, but at room temperature is not tacky to the touch as opposed to the aggressive tack of pressure sensitive adhesives.

Unless otherwise indicated, the terms “transparent’ and “optically transparent” are used interchangeably and refer to an article, film or adhesive that has a high light transmittance (typically at least 90% transmittance) over at least a portion of the visible light spectrum (about 400 to about 700 nm). The term “transparent film” refers to a film having a thickness and when the film is disposed on a substrate, an image (disposed on or adjacent to the substrate) is visible through the thickness of the transparent film. In many embodiments, a transparent film allows the image to be seen through the thickness of the film without substantial loss of image clarity. In some embodiments, the transparent film has a matte or glossy finish.

As used herein, the term “optically clear” refers to articles, films, or adhesives that have high light transmittance (typically at least 95% transmittance) over at least a portion of the visible light spectrum (about 400 to about 700 nm) and have low haze (typically 5% or less). Light transmittance and haze can be measured using standard optical techniques.

As used herein, the term “siloxane-based” refers to polymeric materials that contain siloxane repeat units of the type —(SiR₂O)—, where R is a hydrocarbon group such as an alkyl, aryl or the like. The terms “siloxane” and “silicone” are used interchangeably herein.

As used herein, the term “polymer” refers to a polymeric material that is a homopolymer or a copolymer. As used herein, the term “homopolymer” refers to a polymeric material that is the reaction product of one monomer. As used herein, the term “copolymer” refers to a polymeric material that is the reaction product of at least two different monomers.

The terms “tackifying resin”, “tackifying agent” and “tackifier” are used interchangeably herein.

The terms “plasticizing resin”, “plasticizing agent” and “plasticizer” are used interchangeably herein.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The terms “oxalylamino” and “aminoxalyl” are used interchangeably to refer to a divalent group of formula —(CO)—(CO)—NH— where each (CO) denotes a carbonyl.

As used herein, the term “wet out” when referring to an adhesive layer refers to the ability of the adhesive to spontaneously spread out upon and bond to the contact surface.

As used herein, the term “self-wetting” when referring to an adhesive layer refers to an adhesive layer that spontaneously wets out a surface without the need to apply external pressure.

As used herein, the term “nanostructured” when referring to a coating on a surface, refers to a coating that comprises nanostructures. A nanostructure is a structure of intermediate size between microscopic and molecular structures. Nanostructural detail is microstructure at nanoscale. As used herein, the term “microstructure” means the configuration of features wherein at least 2 dimensions of the features are microscopic. The topical and/or cross-sectional view of the features must be microscopic. As used herein, the term “microscopic” refers to features of small enough dimension so as to require an optic aid to the naked eye when viewed from any plane of view to determine its shape. One criterion is found in Modern Optic Engineering by W. J. Smith, McGraw-Hill, 1966, pages 104-105 whereby visual acuity, “ . . . is defined and measured in terms of the angular size of the smallest character that can be recognized.” Normal visual acuity is considered to be when the smallest recognizable letter subtends an angular height of 5 minutes of arc on the retina. At typical working distance of 250 mm (10 inches), this yields a lateral dimension of 0.36 mm (0.0145 inch) for this object. Nanostructured surfaces contain structural features that are between 0.1 and 100 nanometers in size in at least two dimensions.

The terms “room temperature” and “ambient temperature” are used interchangeably and refer to a temperature of from 20-25° C.

The terms “Tg” and “glass transition temperature” are used interchangeably and refer to the glass transition temperature of a polymeric composition. Unless otherwise specified, the glass transition temperature, if measured, is measured by DSC (Differential Scanning calorimetry) using well understood techniques (typically with a heating time of 10° C. per minute). More typically the Tg is calculated using the well-known and understood Fox equation with monomer Tg values provided by the monomer supplier, as is well understood by one of skill in the polymer arts.

As used herein the term “UV radiation at or below the B spectral range” is used according to the commonly understood meaning of this spectral range. Ultraviolet or UV radiation is a portion of the electromagnetic spectrum located in the wavelength region between visible light and X-ray radiation with wavelengths of from 400 nanometers (nm) to 10 nm. UV radiation is typically subdivided into regions that are described as UVA (315-400 nm), UVB (280-315 nm) and UVC (100-280). In nature, the long wavelength UVA light is not absorbed by the ozone layer, the medium wavelength UVB is mostly absorbed by the ozone layer, and the short wavelength UVC is completely absorbed by the ozone layer. Thus UVC and much of UVB radiation is not present in natural light.

Disclosed herein are protective film articles comprising a thermally stable tape backing with a first major surface and a second major surface, a primer layer on the first major surface of the thermally stable tape backing, and a self-wetting, tack-free adhesive layer at least partially coated on the primer layer. The tack-free adhesive layer comprises at least one siloxane-based elastomeric polymer that is unchanged after heat aging of 180° C. for 30 minutes, and is able to removably adhere to an optical or electronic device without leaving residue on the optical or electronic device.

The protective film articles or processing tapes include a thermally stable tape backing. By “thermally stable tape backing” it is meant that the tape backing is able to be exposed to the elevated temperature conditions processing conditions desired for the tape article without chemical or physical change, that is to say without degrading, hardening, shrinking, buckling wrinkling or the like. Typically the thermally stable tape backing is able to withstand heat aging of 180° C. for 30 minutes without being chemically or conformationally changed.

In some embodiments, the thermally stable tape backing is a polymeric film comprising a polyester film. Examples of thermally stable polyester films include certain polyesters such as annealed polyethylene terephthalate (PET), amorphous co-polyesters such as those commercially available from Eastman Chemicals as “TRITAN”. In other embodiments the thermally stable tape backing is a polymeric film comprising a polyimide film. Examples of suitable polyimide films are those commercially available from DuPont as “KAPTON”.

While a wide range of thicknesses are suitable for the thermally stable tape backing, typically the thermally stable tape backing has a thickness of from 51 micrometers to 102 micrometers (2-4 mils).

At least one surface of the thermally stable tape backing comprises a surface primer layer. Primers are known surface treatment agents that can be applied to a film surface to provide a chemically modified surface. The applied self-wetting, tack-free adhesive layer forms a stronger bond to this chemically modified surface than it would to the surface without the primer present. In some embodiments, the surface primer is a conventional type of surface primer, and in other particularly suitable embodiments, the surface primer comprises a plasma-coated discontinuous silane-based primer layer.

Among the suitable primers for use to modify a surface of a thermally stable tape backing are aqueous primers. Aqueous primers are those in which the primer materials are dissolved or suspended in water. Aqueous primers are particularly suitable because solvent-based primers could partially dissolve the film surface causing dimensional changes, structural changes or optical changes, that is to say, the films could become thinner, weaker or opaque. Aqueous primers, however have not been found to cause these undesirable changes in films, such as thermally stable tape backings. Particularly suitable aqueous primers include aqueous primers that include a mixture of silica and organosilanes. Such primers are described in, for example, in European Patent No. EP 372,756.

The primer may be applied to the film surface using any suitable coating technique. For example, the primer can be coated by such methods as knife coating, roll coating, gravure coating, rod coating, spray coating, curtain coating, and air knife coating. The primer may also be printed by known methods such as screen printing or inkjet printing. The coated aqueous primer layer is then dried to remove the water and any additional water-miscible co-solvents that might be present. Typically, the coated primer layer is subjected to elevated temperatures, such as those supplied by an oven, to expedite drying of the primer layer.

A particularly suitable surface primer comprises a plasma-coated discontinuous silane-based primer layer. Typically, the plasma-coated discontinuous silane-based primer layer comprises nanostructures. Generally, the nanostructures comprise silanol-functional groups.

Typically the primer surface coating is applied to the surface of the thermally stable tape backing by plasma deposition. Such plasma deposition techniques are described in PCT Publication No. WO 2015/013387 (David et al.). The method of forming the primer layer involves depositing a layer to a major surface of a substrate by plasma chemical vapor deposition from a gaseous mixture while substantially simultaneously etching the surface with a reactive species. The method includes providing a substrate surface, mixing a first gaseous species capable of depositing a layer onto the substrate when formed into a plasma, with a second gaseous species capable of etching the substrate when formed into a plasma, thereby forming a gaseous mixture, forming the gaseous mixture into a plasma, and exposing the surface of the substrate to the plasma. The surface is etched and a layer is deposited on at least a portion of the etched surface substantially simultaneously. Typically nanostructures are formed on the substrate surface. In the present disclosure, the plasma coated primer comprises at least one organosilicon compound, and therefore the primed surface is described as silane-based.

A method of making a nanostructure and nanostructured articles by depositing a layer to a major surface of a substrate by plasma chemical vapor deposition from a gaseous mixture while substantially simultaneously etching the surface with a reactive species. The plasma vapor deposition has several very desirable features for preparing the primer layer. While not wishing to be bound by theory, it is believed that the combination of physical modification to the surface to generate a roughened surface that provides increased surface area for adhesion, and the deposition of a primer layer that is free from migratory species that can become detached from the surface and thus weaken the adhesion to the surface, provides the very desirable primer surface.

The method includes providing a substrate, mixing a first gaseous species capable of depositing a layer onto the substrate when formed into a plasma, with a second gaseous species capable of etching the substrate when formed into a plasma, thereby forming a gaseous mixture forming the gaseous mixture into a plasma and exposing a surface of the substrate to the plasma, wherein the surface is etched and a layer is deposited on at least a portion of the etched surface substantially simultaneously, thereby forming the nanostructures typically are silanol-functional, that is to say they contain —Si—OH terminal groups. The nanostructures have a high aspect ratio and typically have random dimensions in at least one dimension and generally in three orthogonal dimensions.

The protective film article also includes a self-wetting, tack-free adhesive layer in contact with the primer layer. A wide range of self-wetting, tack-free adhesive layers can be used. Typically the self-wetting, tack-free adhesive layer comprises at least one crosslinked siloxane-based elastomeric polymer.

A range of crosslinked siloxane-based elastomeric polymers may be used. In most embodiments, the at least one siloxane-based elastomeric polymer comprises a polydiorganosiloxane polyurea copolymer or a polydiorganosiloxane polyoxamide copolymer.

One example of a useful class of siloxane elastomeric polymers is urea-based siloxane polymers such as siloxane polyurea block copolymers. Siloxane polyurea block copolymers include the reaction product of a polydiorganosiloxane diamine (also referred to as a silicone diamine), a diisocyanate, and optionally an organic polyamine. Suitable siloxane polyurea block copolymers are represented by the repeating unit of Structure I below:

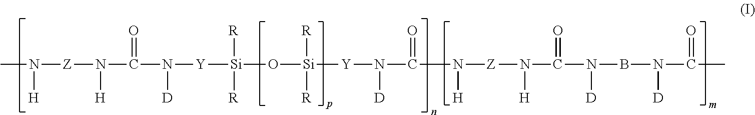

wherein

each R is a moiety that, independently, is an alkyl moiety, having about 1 to 12 carbon atoms, and may be substituted with, for example, trifluoroalkyl or vinyl groups, a vinyl radical or higher alkenyl radical represented by the formula —R^{d}(CH₂)ₐCH═CH₂ wherein the R^{d} group is —(CH₂)_{b}— or —(CH₂)_{c}CH═CH— and a is 1, 2 or 3; b is 0, 3 or 6; and c is 3, 4 or 5, a cycloalkyl moiety having from about 6 to 12 carbon atoms and may be substituted with alkyl, fluoroalkyl, and vinyl groups, or an aryl moiety having from about 6 to 20 carbon atoms and may be substituted with, for example, alkyl, cycloalkyl, fluoroalkyl and vinyl groups or R is a perfluoroalkyl group as described in U.S. Pat. No. 5,028,679, or a fluorine-containing group, as described in U.S. Pat. No. 5,236,997, or a perfluoroether-containing group, as described in U.S. Pat. Nos. 4,900,474 and 5,118,775; typically, at least 50% of the R moieties are methyl radicals with the balance being monovalent alkyl or substituted alkyl radicals having from 1 to 12 carbon atoms, alkenyl radicals, phenyl radicals, or substituted phenyl radicals;

each Z is a polyvalent radical that is an arylene radical or an aralkylene radical having from about 6 to 20 carbon atoms, an alkylene or cycloalkylene radical having from about 6 to 20 carbon atoms, in some embodiments Z is 2,6-tolylene, 4,4′-methylenediphenylene, 3,3′-dimethoxy-4,4′-biphenylene, tetramethyl-m-xylylene, 4,4′-methylenedicyclohexylene, 3,5,5-trimethyl-3-methylenecyclohexylcne, 1,6-hexamethylene, 1,4-cyclohexylene, 2,2,4-trimethylhexylene and mixtures thereof; each Y is a polyvalent radical that independently is an alkylene radical of 1 to 10 carbon atoms, an aralkylene radical or an arylene radical having 6 to 20 carbon atoms;

each D is selected from the group consisting of hydrogen, an alkyl radical of 1 to 10 carbon atoms, phenyl, and a radical that completes a ring structure including B or Y to form a heterocycle;

where B is a polyvalent radical selected from the group consisting of alkylene, aralkylene, cycloalkylene, phenylene, heteroalkylene, including for example, polyethylene oxide, polypropylene oxide, polytetramethylene oxide, and copolymers and mixtures thereof;

m is a number that is 0 to about 1000;

n is a number that is at least 1; and

p is a number that is at least 10, in some embodiments 15 to about 2000, or even 30 to 1500.

Useful siloxane polyurea block copolymers are disclosed in, e.g., U.S. Pat. Nos. 5,512,650, 5,214,119, 5,461,134, and 7,153,924 and PCT Publication Nos. WO 96/35458, WO 98/17726, WO 96/34028, WO 96/34030 and WO 97/40103.

Another useful class of siloxane elastomeric polymers are oxamide-based polymers such as polydiorganosiloxane polyoxamide block copolymers. Examples of polydiorganosiloxane polyoxamide block copolymers are presented, for example, in US Patent Publication No. 2007-0148475. The polydiorganosiloxane polyoxamide block copolymer contains at least two repeat units of Formula II below:

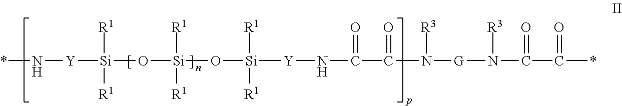

In this formula, each R¹ is independently an alkyl, haloalkyl, aralkyl, alkenyl, aryl, or aryl substituted with an alkyl, alkoxy, or halo, wherein at least 50 percent of the R¹ groups are methyl. Each Y is independently an alkylene, aralkylene, or a combination thereof. Subscript n is independently an integer of 40 to 1500 and the subscript p is an integer of 1 to 10. Group G is a divalent group that is the residue unit that is equal to a diamine of formula R³HN-G-NHR³ minus the two —NHR³ groups. Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine or the like). Each asterisk (*) indicates a site of attachment of the repeat unit to another group in the copolymer such as, for example, another repeat unit of Formula II.

Suitable alkyl groups for R¹ in Formula II typically have 1 to 10, 1 to 6, or 1 to 4 carbon atoms. Exemplary alkyl groups include, but are not limited to, methyl, ethyl, isopropyl, n-propyl, n-butyl, and iso-butyl. Suitable haloalkyl groups for R¹ often have only a portion of the hydrogen atoms of the corresponding alkyl group replaced with a halogen. Exemplary haloalkyl groups include chloroalkyl and fluoroalkyl groups with 1 to 3 halo atoms and 3 to 10 carbon atoms. Suitable alkenyl groups for R¹ often have 2 to 10 carbon atoms. Exemplary alkenyl groups often have 2 to 8, 2 to 6, or 2 to 4 carbon atoms such as ethenyl, n-propenyl, and n-butenyl. Suitable aryl groups for R¹ often have 6 to 12 carbon atoms. Phenyl is an exemplary aryl group. The aryl group can be unsubstituted or substituted with an alkyl (e.g., an alkyl having 1 to 10 carbon atoms, 1 to 6 carbon atoms, or 1 to 4 carbon atoms), an alkoxy (e.g., an alkoxy having 1 to 10 carbon atoms, 1 to 6 carbon atoms, or 1 to 4 carbon atoms), or halo (e.g., chloro, bromo, or fluoro). Suitable aralkyl groups for R¹ usually have an alkylene group having 1 to 10 carbon atoms and an aryl group having 6 to 12 carbon atoms. In some exemplary aralkyl groups, the aryl group is phenyl and the alkylene group has 1 to 10 carbon atoms, 1 to 6 carbon atoms, or 1 to 4 carbon atoms (i.e., the structure of the aralkyl is alkylene-phenyl where an alkylene is bonded to a phenyl group).

At least 50 percent of the R¹ groups are methyl. For example, at least 60 percent, at least 70 percent, at least 80 percent, at least 90 percent, at least 95 percent, at least 98 percent, or at least 99 percent of the R¹ groups can be methyl. The remaining R¹ groups can be selected from an alkyl having at least two carbon atoms, haloalkyl, aralkyl, alkenyl, aryl, or aryl substituted with an alkyl, alkoxy, or halo.

Each Y in Formula II is independently an alkylene, aralkylene, or a combination thereof. Suitable alkylene groups typically have up to 10 carbon atoms, up to 8 carbon atoms, up to 6 carbon atoms, or up to 4 carbon atoms. Exemplary alkylene groups include methylene, ethylene, propylene, butylene, and the like. Suitable aralkylene groups usually have an arylene group having 6 to 12 carbon atoms bonded to an alkylene group having 1 to 10 carbon atoms. In some exemplary aralkylene groups, the arylene portion is phenylene. That is, the divalent aralkylene group is phenylene-alkylene where the phenylene is bonded to an alkylene having 1 to 10, 1 to 8, 1 to 6, or 1 to 4 carbon atoms. As used herein with reference to group Y, “a combination thereof” refers to a combination of two or more groups selected from an alkylene and aralkylene group. A combination can be, for example, a single aralkylene bonded to a single alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

Each subscript n in Formula II is independently an integer of 40 to 1500. For example, subscript n can be an integer up to 1000, up to 500, up to 400, up to 300, up to 200, up to 100, up to 80, or up to 60. The value of n is often at least 40, at least 45, at least 50, or at least 55. For example, subscript n can be in the range of 40 to 1000, 40 to 500, 50 to 500, 50 to 400, 50 to 300, 50 to 200, 50 to 100, 50 to 80, or 50 to 60.

The subscript p is an integer of 1 to 10. For example, the value of p is often an integer up to 9, up to 8, up to 7, up to 6, up to 5, up to 4, up to 3, or up to 2. The value of p can be in the range of 1 to 8, 1 to 6, or 1 to 4.

Group G in Formula II is a residual unit that is equal to a diamine compound of formula R³HN-G-NHR³ minus the two amino groups (i.e., —NHR³ groups). Group R³ is hydrogen or alkyl (e.g., an alkyl having 1 to 10, 1 to 6, or 1 to 4 carbon atoms) or R³ taken together with G and with the nitrogen to which they are both attached forms a heterocyclic group (e.g., R³HN-G-NHR³ is piperazine). The diamine can have primary or secondary amino groups. In most embodiments, R³ is hydrogen or an alkyl. In many embodiments, both of the amino groups of the diamine are primary amino groups (i.e., both R³ groups are hydrogen) and the diamine is of formula H₂N-G-NH₂.

In some embodiments, G is an alkylene, heteroalkylene, polydiorganosiloxane, arylene, aralkylene, or a combination thereof. Suitable alkylenes often have 2 to 10, 2 to 6, or 2 to 4 carbon atoms. Exemplary alkylene groups include ethylene, propylene, butylene, and the like. Suitable heteroalkylenes are often polyoxyalkylenes such as polyoxyethylene having at least 2 ethylene units, polyoxypropylene having at least 2 propylene units, or copolymers thereof. Suitable polydiorganosiloxanes include the polydiorganosiloxane diamines of Formula II, which are described above, minus the two amino groups. Exemplary polydiorganosiloxanes include, but are not limited to, polydimethylsiloxanes with alkylene Y groups. Suitable aralkylene groups usually contain an arylene group having 6 to 12 carbon atoms bonded to an alkylene group having 1 to 10 carbon atoms. Some exemplary aralkylene groups are phenylene-alkylene where the phenylene is bonded to an alkylene having 1 to 10 carbon atoms, 1 to 8 carbon atoms, 1 to 6 carbon atoms, or 1 to 4 carbon atoms. As used herein with reference to group G, “a combination thereof” refers to a combination of two or more groups selected from an alkylene, heteroalkylene, polydiorganosiloxane, arylene, and aralkylene. A combination can be, for example, an aralkylene bonded to an alkylene (e.g., alkylene-arylene-alkylene). In one exemplary alkylene-arylene-alkylene combination, the arylene is phenylene and each alkylene has 1 to 10, 1 to 6, or 1 to 4 carbon atoms.

The polydiorganosiloxane polyoxamide tends to be free of groups having a formula —R^{a}—(CO)—NH— where R^{a} is an alkylene. All of the carbonylamino groups along the backbone of the copolymeric material are part of an oxalylamino group (i.e., the —(CO)—(CO)—NH— group). That is, any carbonyl group along the backbone of the copolymeric material is bonded to another carbonyl group and is part of an oxalyl group. More specifically, the polydiorganosiloxane polyoxamide has a plurality of aminoxalylamino groups.

The polydiorganosiloxane polyoxamide is a linear, block copolymer and is an elastomeric material. Unlike many of the known polydiorganosiloxane polyamides that are generally formulated as brittle solids or hard plastics, the polydiorganosiloxane polyoxamides can be formulated to include greater than 50 weight percent polydiorganosiloxane segments based on the weight of the copolymer. The weight percent of the diorganosiloxane in the polydiorganosiloxane polyoxamides can be increased by using higher molecular weight polydiorganosiloxanes segments to provide greater than 60 weight percent, greater than 70 weight percent, greater than 80 weight percent, greater than 90 weight percent, greater than 95 weight percent, or greater than 98 weight percent of the polydiorganosiloxane segments in the polydiorganosiloxane polyoxamides. Higher amounts of the polydiorganosiloxane can be used to prepare elastomeric materials with lower modulus while maintaining reasonable strength.

Typically, the number average molecular weight of the polydiorganosiloxane polyoxamide copolymer or polydiorganosiloxane polyurea copolymer prior to be being crosslinked is in the range of 10,000-60,000 grams/mole. In some embodiments, the polydiorganosiloxane polyoxamide copolymer or polydiorganosiloxane polyurea copolymer has a number average molecular weight of at least 40,000 grams/mole.

The polydiorganosiloxane polyoxamide copolymer or polydiorganosiloxane polyurea copolymer is crosslinked. A wide variety of crosslinking techniques can be used to effect crosslinking of the copolymers. Generally the polydiroganosiloxane copolymers are crosslinked through the use of free radical initiators (either thermal initiators or photoinitiators), or by exposure to electron beam (e-beam) or gamma radiation, or a combination of e-beam and gamma radiation. In this disclosure, the terms crosslinking and curing are used interchangeably, whereas typically curing merely encompasses polymerization that may or may not involve crosslinking.

Suitable free radical initiators include organic peroxide or hydroperoxides and photoinitoars such as benzoin ethers, benophenone, and derivatives thereof. Examples of peroxide initiators include, but are not limited to, benzoyl peroxide, acetyl peroxide, lauroyl peroxide, decanoyl peroxide, dicetyl peroxydicarbonate, di(2-ethylhexyl) peroxydicarbonate, t-butylperoxypivalate (LUPERSOL 11, available from Atochem), t-butylperoxy-2-ethylhexanoate (TRIGONOX 21-050, available from AkzoNobel Polymer Chemicals, Inc.), and dicumyl peroxide. A particularly suitable commercially available peroxide initiator is PERKADOX PD-50S-PS-A, available from AkzoNobel Polymer Chemicals.

A variety of procedures for e-beam and gamma ray crosslinking are well-known. The cure depends on the specific equipment used, and those skilled in the art can define a dose calibration model for the specific equipment, geometry, and line speed, as well as other well understood process parameters.

Commercially available electron beam generating equipment is readily available. For the examples described herein, the radiation processing was performed on a Model CB-300 electron beam generating apparatus (available from Energy Sciences, Inc. (Wilmington, Mass.). Generally, a support film (e.g., polyester terephthalate support film) runs through a chamber. In some embodiments, a sample of uncured material with a liner (e.g., a fluorosilicone release liner) on both sides (“closed face”) may be attached to the support film and conveyed at a fixed speed of about 6.1 meters/min (20 feet/min). In some embodiments, a sample of the uncured material may be applied to one liner, with no liner on the opposite surface (“open face”). Generally, the chamber is inerted (e.g., the oxygen-containing room air is replaced with an inert gas, e.g., nitrogen) while the samples are e-beam cured, particularly when open-face curing.

The uncured material may be exposed to e-beam irradiation from one side through a release liner or carrier film. For making a single layer laminating adhesive type tape, a single pass through the electron beam may be sufficient. Thicker samples, may exhibit a cure gradient through the cross section of the adhesive so that it may be desirable to expose the uncured material to electron beam radiation from both sides. The dose of e-beam radiation delivered can vary dependent upon a number of variables but typically is in the range of 1-10 Mrads. In some embodiments the dose of e-beam radiation is about 7 Mrads.

Commercially available gamma irradiation equipment includes equipment often used for gamma irradiation sterilization of products for medical applications.

The level of crosslinking can be controlled even after the composition has been crosslinked by selectively depolymerizing the crosslinked polymer when the polymer comprises a polydiorganosiloxane polyoxamide segmented copolymer. It has recently been discovered that the polyoxamide linkage selectively absorbs UV radiation above the UVB spectral range. Upon the absorption of UV radiation the polyoxamide linkage breaks. The breaking of polyoxamide linkages is essentially the opposite of crosslinking and can be used to decrease the level of crosslinking in the polymer composition. In this way, the polymers can be tailored to give the desired properties even after the polymer has been crosslinked. Typically once a polymer is crosslinked, it is very difficult to modify the properties of the polymer.

The self-wetting, tack-free adhesive layer may optionally include at least one additive. Suitable additives include tackifying resins, non-migrating plasticizing agents, antistatic agents, particles, dyes, optical filtering UV light absorbers, chromophores, or combinations thereof.

In some embodiments, the additive comprises a tackifying resin, typically an MQ siloxane resin. It should be noted that in this disclosure the tackifying resin is not added in sufficient quantities to rend the adhesive layer tacky to the touch. It is well understood in the siloxane art that typically high levels of MQ tackifying resin (often 50% or more by weight) are required to render tacky polydiorganosiloxane polymers such as those described above.

The adhesive layer also includes at least one siloxane tackifying resin. Suitable siloxane tackifying resins include those resins composed of the following structural units M (i.e., monovalent R′₃SiO_{1/2} units), D (i.e., divalent R′₂SiO_{2/2} units), T (i.e., trivalent R′SiO_{3/2} units), and Q (i.e., quaternary SiO_{4/2} units), and combinations thereof. Typical exemplary siloxane resins include MQ siloxane tackifying resins, MQD siloxane tackifying resins, and MQT siloxane tackifying resins. These siloxane tackifying resins usually have a number average molecular weight in the range of 100 to 50,000 or in the range of 500 to 15,000 and generally have methyl R′ groups.

MQ siloxane tackifying resins are copolymeric resins having R′₃SiO_{1/2} units (“M” units) and SiO_{4/2} units (“Q” units), where the M units are bonded to the Q units, each of which is bonded to at least one other Q unit. Some of the SiO_{4/2} units (“Q” units) are bonded to hydroxyl radicals resulting in HOSiO_{3/2} units (“T^{OH}” units), thereby accounting for the silicon-bonded hydroxyl content of the siloxane tackifying resin, and some are bonded only to other SiO_{4/2} units.

Such resins are described in, for example, Encyclopedia of Polymer Science and Engineering, vol. 15, John Wiley & Sons, New York, (1989), pp. 265-270, and U.S. Pat. No. 2,676,182 (Daudt et al.), U.S. Pat. No. 3,627,851 (Brady), U.S. Pat. No. 3,772,247 (Flannigan), and U.S. Pat. No. 5,248,739 (Schmidt et al.). Other examples are disclosed in U.S. Pat. No. 5,082,706 (Tangney). The above-described resins are generally prepared in solvent. Dried or solventless, M siloxane tackifying resins can be prepared, as described in U.S. Pat. No. 5,319,040 (Wengrovius et al.), U.S. Pat. No. 5,302,685 (Tsumura et al.), and U.S. Pat. No. 4,935,484 (Wolfgruber et al.).

Certain MQ siloxane tackifying resins can be prepared by the silica hydrosol capping process described in U.S. Pat. No. 2,676,182 (Daudt et al.) as modified according to U.S. Pat. No. 3,627,851 (Brady), and U.S. Pat. No. 3,772,247 (Flannigan). These modified processes often include limiting the concentration of the sodium silicate solution, and/or the silicon-to-sodium ratio in the sodium silicate, and/or the time before capping the neutralized sodium silicate solution to generally lower values than those disclosed by Daudt et al. The neutralized silica hydrosol is often stabilized with an alcohol, such as 2-propanol, and capped with R₃SiO_{1/2} siloxane units as soon as possible after being neutralized. The level of silicon bonded hydroxyl groups (i.e., silanol) on the MQ resin may be reduced to no greater than 1.5 weight percent, no greater than 1.2 weight percent, no greater than 1.0 weight percent, or no greater than 0.8 weight percent based on the weight of the siloxane tackifying resin. This may be accomplished, for example, by reacting hexamethyldisilazane with the siloxane tackifying resin. Such a reaction may be catalyzed, for example, with trifluoroacetic acid. Alternatively, trimethylchlorosilane or trimethylsilylacetamide may be reacted with the siloxane tackifying resin, a catalyst not being necessary in this case.

MQD silicone tackifying resins are terpolymers having R′₃SiO_{1/2} units (“M” units), SiO_{4/2} units (“Q” units), and R′₂SiO_{2/2} units (“D” units) such as are taught in U.S. Pat. No. 2,736,721 (Dexter). In MQD silicone tackifying resins, some of the methyl R′ groups of the R′₂SiO_{2/2} units (“D” units) can be replaced with vinyl (CH₂═CH—) groups (“D^{Vi}” units).

MQT siloxane tackifying resins are terpolymers having R′₃SiO_{1/2} units, SiO_{4/2} units and R′SiO_{3/2} units (“T” units) such as are taught in U.S. Pat. No. 5,110,890 (Butler) and Japanese Kokai HE 2-36234.

Suitable siloxane tackifying resins are commercially available from sources such as Dow Corning, Midland, Mich., General Electric Silicones Waterford, N.Y. and Rhodia Silicones, Rock Hill, S.C. Examples of particularly useful MQ siloxane tackifying resins include those available under the trade designations SR-545 and SR-1000, both of which are commercially available from GE Silicones, Waterford, N.Y. Such resins are generally supplied in organic solvent and may be employed as received. Blends of two or more siloxane resins can be included in the reactive mixtures of this disclosure.

Typically, if used the siloxane tackifying resin is present in the adhesive layer in an amount of 10% or less by weight, based upon the total weight of solids of the adhesive layer.

In some embodiments, that additive comprises a dye or other color changing additive such that upon exposure to heat (thermochromic material) or to a specific range of light wavelengths (photochromic material), such as UV light for example, the dye of color changing additive changes color or becomes visible to an observer. An advantage of this type of additive is that with optical films, such as optically clear films, it can be difficult to locate the edge of the film. In this way the observer can locate the edges of the film by locating where the additive has become visible. This process can be used to aid human handlers (using their eyes) or mechanical handlers (using a detector). When the article containing the additive is not exposed to heat (for thermochromic additives) or to the specific range of light wavelengths (for photochromic additives), the additive is generally not visible.

The self-wetting, tack-free adhesive layer can have a variety of thicknesses depending upon a variety of factors such as the desired use for the protective film article, and the like. Typically the self-wetting, tack-free adhesive layer has a thickness of from 13 micrometers to 25 micrometers (0.5-1.0 mils).

Besides being self-wetting, the tack-free adhesive layer may have a variety of desirable features. Among these features are optical properties, repositionability, and removability. The desirable optical properties are described in greater detail below.

Repositionability refers to the ability of the adhesive layer to be placed on a surface and easily removed from the surface and re-attached to the surface. Removability on the other hand, refers to the adhesive being able to dwell on a surface for extended periods of time without the adhesion increasing and after dwelling on the surface for extended periods of time and various conditions (heat, pressure, etc) the adhesive layer is cleanly removable from the surface. By cleanly removable it is meant that no residue from the adhesive layer is left behind on the surface and no part of the surface is pulled away from the surface when the adhesive layer is removed. As mentioned above, it is desirable that the adhesive layer be removable even after being exposed to conditions such as heat aging.

Depending upon the desired use for the protective film article, it may desirable that the protective film article be transparent to electromagnetic radiation of wavelengths of the infrared region, the visible region, the ultraviolet region, or a combination thereof. Each of these wavelength regions of the electromagnetic spectrum are well understood in the art. Typically infrared light encompasses wavelengths of from 1000 nm to 700 nm; visible light encompasses from 700 nm to 400 nm; and UV encompasses from 400 nm to 10 nm. In some embodiments it may be desirable for the protective film to transparent to some wavelengths and opaque to others. For example if the protective film article is protecting a surface that is to be processed by exposure to UV light, it may be desirable for the film article to be transparent to UV light.

In some embodiments, it is desirable for the protective film article to be optically transparent, that is to say transparent to at least some wavelengths of visible light such that the protective film article transmits at least 90% of the visible light and has low haze (i.e. haze of 10% or less). This can be particularly important if the surface to which the protective film article is attached is part of an optical article and it is desirable to observe the surface when the protective film article is attached, such as during processing steps. In some embodiments, the protective film is optically clear having a visible light transmittance of at least 95%, and a haze of 5% or less.

Also disclosed herein are methods of preparing optical or electronic articles using the protective film articles or processing tapes of this disclosure. These methods include providing an optical or electronic construction comprising a first major surface and a second major surface, providing a protective film article as described above, adhering the tack-free adhesive layer of the protective film article to the second major surface of the optical or electronic construction to form a laminate, subjecting the optical laminate to a at least one processing step, and cleanly removing the protective film article from the second major surface of the optical or electronic construction. As described above, the protective film article comprises a thermally stable tape backing with a first major surface and a second major surface, a primer layer on the first major surface of the thermally stable tape backing, and a self-wetting, tack-free adhesive layer at least partially coated on the primer layer, wherein the self-wetting tack-free adhesive layer comprises at least one siloxane-based elastomeric polymer that is unchanged after heat aging of 180° C. for 30 minutes, and is able to removably adhere to an optical or electronic device without leaving residue on the optical or electronic device.

The at least one processing step encompasses wide range of processing steps. This includes embodiments where the laminates are subjected to a single processing step, such as shipment from one location to another, as well as embodiments that involve multiple processing steps. Embodiments that involve multiple processing steps include embodiments where a sequence of processing steps are used, embodiments where different process steps are used simultaneously, and combinations thereof. Examples of sequential processing steps include, for example shipment of the laminate from one location to another followed by attachment to another device. Examples of simultaneous processing steps include ones in which the optical or electronic is simultaneously exposed to both heat and radiation.

The disclosure includes the following embodiments:

Among the embodiments are protective film articles. Embodiment 1 is a protective film article comprising: a thermally stable tape backing with a first major surface and a second major surface; a primer layer on the first major surface of the thermally stable tape backing; and a self-wetting, tack-free adhesive layer at least partially coated on the primer layer, wherein the tack-free adhesive layer comprises at least one siloxane-based elastomeric polymer that is unchanged after heat aging of 180° C. for 30 minutes, and is able to removably adhere to an optical or electronic device without leaving residue on the optical or electronic device.

Embodiment 2 is the protective film article of embodiment 1, wherein the thermally stable tape backing comprises a polyester film.

Embodiment 3 is the protective film article of embodiment 1, wherein the thermally stable tape backing comprises a polyimide film.

Embodiment 4 is the protective film article of any of embodiments 1-3, wherein the thermally stable tape backing has a thickness of from 51 micrometers to 102 micrometers (2-4 mils).

Embodiment 5 is the protective film article of any of embodiments 1-4, wherein the primer layer comprises a plasma-coated discontinuous silane-based primer.

Embodiment 6 is the protective film article of embodiment 5, wherein the plasma-coated discontinuous silane-based primer layer comprises nanostructures.

Embodiment 7 is the protective film article of embodiment 5 or 6, wherein the nanostructures comprise silanol-functional groups.

Embodiment 8 is the protective film article of any of embodiments 1-7, wherein the self-wetting, tack-free adhesive layer comprises a crosslinked siloxane-based elastomeric polymer.

Embodiment 9 is the protective film article of any of embodiments 1-8, wherein the at least one siloxane-based elastomeric polymer comprises a crosslinked polydiorganosiloxane polyurea copolymer or a crosslinked polydiorganosiloxane polyoxamide copolymer.

Embodiment 10 is the protective film article of embodiment 9, wherein the crosslinked polydiorganosiloxane polyoxamide copolymer or the crosslinked polydiorganosiloxane polyurea copolymer has a number average molecular weight of at least 40,000 grams/mole prior to crosslinking.

Embodiment 11 is the protective film article of any of embodiments 1-10, wherein the at least one siloxane-based copolymer comprises a siloxane polyurea-based segmented copolymer comprising at least one repeat unit of the general structure I:

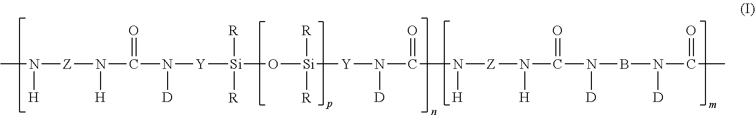

wherein
each R independently is an alkyl, substituted alkyl, cycloalkyl, aryl, or substituted aryl;
each Z is a polyvalent radical of an arylene, an aralkylene, an alkylene, or a cycloalkylene;
each Y is a polyvalent radical that independently is an alkylene, an aralkylene, or an arylene radical;
each D is selected from the group consisting of hydrogen, an alkyl radical, phenyl, and
a radical that completes a ring structure including B or Y to form a heterocycle;
B is a polyvalent radical selected from the group consisting of alkylene, aralkylene,
cycloalkylene, phenylene, and heteroalkylene;
m is a number that is 0 to about 1000;
n is a number that is at least 1; and
p is a number that is at least 10.

Embodiment 12 is the protective film article of any of embodiments 1-10, wherein the at least one siloxane-based copolymer comprises a siloxane polyoxamide-based segmented copolymer comprising at least two repeat units of Formula II:

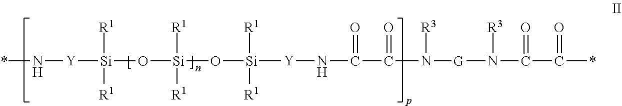

wherein
each R¹ is independently an alkyl, haloalkyl, aralkyl, alkenyl, aryl, or aryl substituted
with an alkyl, alkoxy, or halo;
each Y is independently an alkylene, aralkylene, or a combination thereof;
n is independently an integer of 40 to 1500; and
p is an integer of 1 to 10;
G is a divalent group that is the residue unit that is equal to a diamine of formula R³HN-G-NHR³ minus the two —NHR³ groups, where R³ is hydrogen or alkyl, or R³ taken together with G and with the nitrogen to which they are both attached forms a heterocyclic group; and
each asterisk (*) indicates a site of attachment of the repeat unit to another group in the copolymer.

Embodiment 13 is the protective film article of any of embodiments 1-12, wherein the at least one siloxane-based elastomeric polymer comprises a crosslinked polydiorganosiloxane polyoxamide copolymer which has been subjected to ultraviolet radiation at or below the B spectral range to reduce the level of crosslinking.

Embodiment 14 is the protective film article of any of embodiments 1-13, wherein the self-wetting, tack-free adhesive layer further comprises at least one additive.

Embodiment 15 is the protective film article of embodiment 14, wherein the additive comprises a tackifying resin, a non-migrating plasticizing agent, an antistatic agent, a particle, a dye, an optical filtering UV light absorber, a chromophore, or combinations thereof.

Embodiment 16 is the protective film article of embodiment 15, wherein the tackifying resin comprises an MQ siloxane resin.

Embodiment 17 is the protective film article of embodiment 15, wherein the additive comprises a chromophore selected from a thermochromic material, a photochromic material, or a combination thereof.

Embodiment 18 is the protective film article of any of embodiments 1-17, wherein the protective film article is transparent to electromagnetic radiation of wavelengths of the infrared region, the visible region, the ultraviolet region, or a combination thereof.

Embodiment 19 is the protective film article of embodiment 18, wherein the protective film article is transparent to electromagnetic radiation of wavelengths of the infrared region.

Embodiment 20 is the protective film article of embodiment 18, wherein the protective film article is transparent to electromagnetic radiation of wavelengths of the visible region.

Embodiment 21 is the protective film article of embodiment 18, wherein the protective film article is transparent to electromagnetic radiation of wavelengths of the ultraviolet region.

Embodiment 22 is the protective film article of any of embodiments 1-21, wherein the protective film article is optically clear, having a visible light transmission of at least 95% and a haze of 5% or less.

Embodiment 23 is the protective film article of any of embodiments 1-22, wherein the tack-free adhesive layer has a thickness of from 13-25 micrometers (0.5-1.0 mils).

Among the embodiments are methods of preparing optical or electronic articles. Embodiment 24 includes a method of preparing an optical or electronic article comprising: providing an optical or electronic construction wherein the optical or electronic construction comprises at least a first major surface and a second major surface; providing a protective film article, the protective film article comprising: a thermally stable tape backing with a first major surface and a second major surface; a primer layer on the first major surface of the thermally stable tape backing; and a self-wetting, tack-free adhesive layer at least partially coated on the primer layer, wherein the self-wetting tack-free adhesive layer comprises at least one siloxane-based elastomeric polymer that is unchanged after heat aging of 180° C. for 30 minutes, and is able to removably adhere to an optical or electronic device without leaving residue on the optical or electronic device; adhering the tack-free adhesive layer of the protective film article to the second major surface of the optical or electronic construction to form a laminate; subjecting the optical laminate to at least one processing step; and cleanly removing the protective film article from the second major surface of the optical or electronic construction.

Embodiment 25 is the method of embodiment 24, wherein the thermally stable tape backing comprises a polyester film.

Embodiment 26 is the method of embodiment 24, wherein the thermally stable tape backing comprises a polyimide film.

Embodiment 27 is the method of any of embodiments 23-26, wherein the thermally stable tape backing has a thickness of from 51 micrometers to 102 micrometers (2-4 mils).

Embodiment 28 is the method of any of embodiments 23-27, wherein the primer layer comprises a plasma-coated discontinuous silane-based primer.

Embodiment 29 is the method of embodiment 28, wherein the plasma-coated discontinuous silane-based primer layer comprises nanostructures.

Embodiment 30 is the method of embodiment 28 or 29, wherein the nanostructures comprise silanol-functional groups.

Embodiment 31 is the method of any of embodiments 23-30, wherein the self-wetting, tack-free adhesive layer comprises a crosslinked siloxane-based elastomeric polymer.

Embodiment 32 is the method of any of embodiments 23-31, wherein the at least one siloxane-based elastomeric polymer comprises a crosslinked polydiorganosiloxane polyurea copolymer or a crosslinked polydiorganosiloxane polyoxamide copolymer.

Embodiment 33 is the method of embodiment 32, wherein the crosslinked polydiorganosiloxane polyoxamide copolymer or the crosslinked polydiorganosiloxane polyurea copolymer has a number average molecular weight of at least 40,000 grams/mole prior to crosslinking.

Embodiment 34 is the method of any of embodiments 23-33, wherein the at least one siloxane-based copolymer comprises a siloxane polyurea-based segmented copolymer comprising at least one repeat unit of the general structure I:

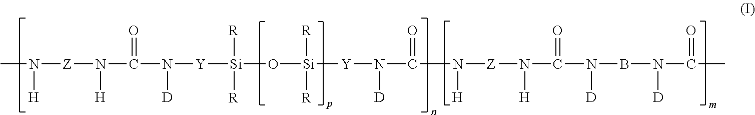

wherein
each R independently is an alkyl, substituted alkyl, cycloalkyl, aryl, or substituted aryl;
each Z is a polyvalent radical of an arylene, an aralkylene, an alkylene, or a cycloalkylene;
each Y is a polyvalent radical that independently is an alkylene, an aralkylene, or an arylene radical;
each D is selected from the group consisting of hydrogen, an alkyl radical, phenyl, and
a radical that completes a ring structure including B or Y to form a heterocycle;
B is a polyvalent radical selected from the group consisting of alkylene, aralkylene,
cycloalkylene, phenylene, and heteroalkylene;
m is a number that is 0 to about 1000;
n is a number that is at least 1; and
p is a number that is at least 10.

Embodiment 35 is the method of any of embodiments 23-33, wherein the at least one siloxane-based copolymer comprises a siloxane polyoxamide-based segmented copolymer comprising at least two repeat units of Formula II:

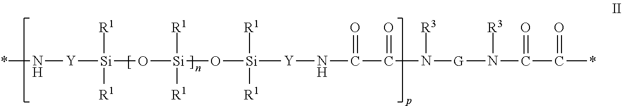

wherein
each R¹ is independently an alkyl, haloalkyl, aralkyl, alkenyl, aryl, or aryl substituted
with an alkyl, alkoxy, or halo;
each Y is independently an alkylene, aralkylene, or a combination thereof;
n is independently an integer of 40 to 1500; and
p is an integer of 1 to 10;
G is a divalent group that is the residue unit that is equal to a diamine of formula R³HN-G-NHR³ minus the two —NHR³ groups, where R³ is hydrogen or alkyl, or R³ taken together with G and with the nitrogen to which they are both attached forms a heterocyclic group; and
each asterisk (*) indicates a site of attachment of the repeat unit to another group in the copolymer.

Embodiment 36 is the method of any of embodiments 23-35, wherein the at least one siloxane-based elastomeric polymer comprises a crosslinked polydiorganosiloxane polyoxamide copolymer which has been subjected to ultraviolet radiation at or below the B spectral range to reduce the level of crosslinking.

Embodiment 37 is the method of any of embodiments 23-36, wherein the self-wetting, tack-free adhesive layer further comprises at least one additive.

Embodiment 38 is the method of embodiment 37, wherein the additive comprises a tackifying resin, a non-migrating plasticizing agent, an antistatic agent, a particle, a dye, an optical filtering UV light absorber, a chromophore, or combinations thereof.

Embodiment 39 is the method of embodiment 38, wherein the tackifying resin comprises an MQ siloxane resin.

Embodiment 40 is the method of embodiment 38, wherein the additive comprises a chromophore selected from a thermochromic material, a photochromic material, or a combination thereof.

Embodiment 41 is the method of any of embodiments 23-40, wherein the protective film article is transparent to electromagnetic radiation of wavelengths of the infrared region, the visible region, the ultraviolet region, or a combination thereof.

Embodiment 42 is the method of embodiment 41, wherein the protective film article is transparent to electromagnetic radiation of wavelengths of the infrared region.

Embodiment 43 is the method of embodiment 41, wherein the protective film article is transparent to electromagnetic radiation of wavelengths of the visible region.

Embodiment 44 is the method of embodiment 41, wherein the protective film article is transparent to electromagnetic radiation of wavelengths of the ultraviolet region.

Embodiment 45 is the method of any of embodiments 23-44, wherein the protective film article is optically clear, having a visible light transmission of at least 95% and a haze of 5% or less.

Embodiment 46 is the method of any of embodiments 23-45, wherein the tack-free adhesive layer has a thickness of from 13-25 micrometers (0.5-1.0 mils).

Embodiment 47 is the method of any of embodiments 23-46, wherein the at least one processing step comprises at least one of heat aging at 180° C. for 30 minutes, transportation of the optical or electronic article, application of pressure or mechanical force, or exposure to radiation.

Embodiment 48 is the method of any of embodiments 23-47, wherein the self-wetting, tack-free adhesive layer is repositionable.

Embodiment 49 is the method of any of embodiments 23-48, wherein the adhesion of the self-wetting, tack-free adhesive layer does not increase after dwelling on the optical or electronic device or upon heat aging.

### Examples

Clean removable, self-wetting protection films that can withstand high thermal incursions were prepared and tested. These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company, St. Louis, Mo. unless otherwise noted. The following abbreviations are used: N=Newtons; cm=centimeters; in =inches; ft=feet; m=meters; Pa=Pascals; min=minutes; mW=milliWatts; ppm=parts per million; kV=kiloVolts; kGy=kiloGray. The terms “weight %”, “% by weight”, and “wt %” are used interchangeably.

Table of Abbreviations

| Abbreviation | Description |
|---|---|
| Elastomer 1 | A polydimethylsiloxane polyoxamide elastomer prepared as described in |
| | Example 16 in U.S. Pat. No. 7,501,184 |
| Resin 1 | Silicone Resin Powder available from Wacker Chemie AG, Munchen, |
| | Germany as MQ 803 TF. |
| Film 1 | 2 mil (51 micrometer) PET film available from Dupont Tejin Films, |
| | Chester, VA as MELINEX 617 |
| Film 2 | 12.5 micrometer polyimide film available from Ube Industries, Minato, |
| | Tokyo, Japan as UPILEX 12.5S |
| Release Liner 1 | Release liner made using the methods and materials described in US |
| | Patent Publication No. 2013/0251961, Example 14. |

### Test Methods

### 90° Peel Adhesion—Modification of ASTM D3330

Sample Preparation:

Adhesive coatings on 51 micrometer PET film with the coating thickness listed in the Tables below were cut into 2.54 centimeter by 15 centimeter strips. Each strip was then adhered to a 6.2 centimeter by 23 centimeter clean, solvent (first IPA and second heptane) washed glass coupon using a 2-kilogram roller passed once over the strip. Note that the UVC Exposure Examples were adhered to quartz glass as described below. The test was modified for different dwell times and temperatures as identified in the results Tables. Some of the bonded assemblies were dwelled at room temperature for 15 minutes. Others were dwelled in an 80° C. oven for 24 hours and then cooled at room temperature for 30 minutes. Others were dwelled in an 80° C. oven for 72 hours and then cooled at room temperature for 30 minutes. Others were dwelled in a 140° C. oven for 30 minutes and then cooled at room temperature for 30 minutes. Others were dwelled in a 180° C. oven for 30 minutes, and then cooled at room temperature for 30 minutes.

90° Peel Adhesion:

The samples were then tested for 90° peel adhesion using an IMASS slip/peel tester with a 90° peel testing assembly (Model SP2000, commercially available from Instrumentors Inc., Strongsville, Ohio) at a rate of 0.3 meters/minute (12 inches/minute) over a five second data collection time. Three samples were tested; the reported peel adhesion value is an average of the peel adhesion value from each of the three samples (unless noted in the results tables). Results are reported in grams/inch.

### Self-Wetting Speed

Tested at room temperature. A cleaned (IPA washed) 2 inch by 4 inch (5.1 cm×10.2 cm) glass plate was placed on a horizontal surface. The protective film was contacted (wet) on one end of the glass, while it is held off the glass from the other end, and then the protective film was let fall onto the glass spontaneously. The time it took the film to completely and fully contact the remaining glass surface was recorded in seconds as the “wetting time”. The shorter the time, the better the self-wetting performance.

### Clean Removal Performance—Ghosting and Residue Evaluation

An approximately 2 inch by 4 inch (5.1 cm×10.2 cm) protective film sample was contacted (wet) onto a slightly smaller sized optically clear glass plate to assure the film sample covered all of the glass surface. A bubble was left between the film and glass. The glass/film sample was placed into 80° C. oven for 24 hours or 140° C. oven for 30 minutes, or 180° C. oven for 30 minutes as noted in Table 2. The sample was cooled for 60 minutes at room temperature. The film was then peeled off, using an LED spot light source (>100 lumen) (FOREST TIGER Flashlight, model number SLH-H509K available from Ningbo Ninghai Zhonghu Electric Co., Ltd., Ningbo City, China) to visually inspect the glass in a dark room by naked eye. The aging performance was scored from 1 (worst) to 5 (best). The score principle described as the follows:

| 5 No | Can't find any difference between bubble area and other area. (If the position of |
|---|---|
| residue | bubble area is unknown before, inspector can't tell where the bubble area is). |
| detected | Then breathe onto the glass. The bubble area can be clearly seen. Stare at the |
| | edge of the bubble area until the fog disappears. Still can't find any difference |
| | between bubble area and other area. |
| 4 | Can't find any difference between bubble area and other area. Then breathe |
| | onto the glass. The bubble area can be clearly seen. Stare at the edge of the |
| | bubble area until the fog disappears. Can find the difference between bubble |
| | area and other area in at least 1 min. |
| 3 | Can find the edge of the bubble area with doubt. But can't find the haze |
| | difference between bubble area and other area. Then breathe onto the glass. The |
| | bubble area can be clearly seen. The suspected bubble edge is verified. |
| 2 | Can find the edge of the bubble area without doubt. Can find the haze |
| | difference between bubble area and other area. |
| 1 | Can find the bubble area with a glance. Can find the bubble area at daylight. |

### Examples

### Primed Film 1 Preparation:

A nanostructure was created on Film 1 using the method described in PCT Patent Publication No. WO 2015/13387, Example 2. A roll of Film 1 was mounted within the chamber, the film was wrapped around the drum electrode, and secured to the take up roll on the opposite side of the drum. The un-wind and take-up tensions were maintained at 3 pounds (13.3 N). The chamber door was closed and the chamber pumped down to a base pressure of 5×10⁴ Torr. The first gaseous species was hexamethyldisiloxane (HMDSO) vapor provided at 70 std·cm³/min, and the second gaseous species was oxygen provided at a flow rate of 2000 std·cm³/min. The pressure during the exposure was around 19-22 mTorr and plasma was turned on at a power of 9000 Watts. The film was advanced at a line speed of 30 ft/minute (900 cm/minute). After plasma treatment, the chamber was vented to atmosphere and the roll removed. This created Primed Film 1.

### Primed Film 2 Preparation:

A nanostructure was created on Film 2 using the plasma treatment system and method described in patent application U.S. Pat. No. 8,634,146 (David et al.) with the following modifications:

The width of the drum electrode was increased to 42.5 inches (108 cm) and the separation between the two compartments within the plasma system was removed so that all the pumping was carried out by means of two turbo-molecular pumps and thus operating at a much lower operating pressure than is conventionally done with plasma processing.

A roll of Film 2 was mounted within the chamber, the film wrapped around the drum electrode and secured to the take up roll on the opposite side of the drum. The unwind and take-up tensions were maintained at 8 (35.5 N), and 12 pounds (53.2 N) respectively. The chamber door was closed and the chamber pumped down to a base pressure of 1 mTorr (0.133 Pa). For the deposition of a discontinuous mask layer, tetramethylsilane gas at a flow rate of 120 std·cm³/min was mixed with argon gas at a flow rate of 500 std·cm³/min. The pressure during the deposition step was around 5 mTorr (0.667 Pa) and plasma was turned on at a power of 600 Watts, and the substrate was treated continuously at a speed of 37 ft/min (0.188 m/s). For the etching step, pure oxygen gas was introduced at a flow rate of 500 std·cm³/min and the operating pressure was nominally 4 mTorr (0.533 Pa). Plasma was turned on at a power of 5000 Watts by applying rf power to the drum and the drum rotation initiated so that the film was transported at a speed of 10 ft/min (0.05 m/s). After plasma treatment, the chamber was vented to atmosphere and the roll removed. This created Primed Film 2.

### Polymer Preparation:

Solution 1 was made from Elastomer 1 dissolved in toluene/IPA at 10% total solids in a 50/50 wt/wt ratio of that solvent mixture.

Solution 2 was Solution 1 with 10% Resin 1 added so the final solids were 90/10, Elastomer 1/Resin 1 wt/wt in toluene/IPA 50/50 wt/wt at a final solids level of 10%.

### Coating and Drying Process:

The two solutions were coated on to Primed Film 1 with a slot die and heated in an oven to remove all the volatile solvent at 70° C. to give a final coating thickness of either 5 or 10 micrometers. Release Liner 1 was laminated to the coated side. This created a silicone elastomer coating between a PET film and a release liner.

### E-Beam Process:

One of two commercially available electron beam units were used to cure the silicone elastomer as noted in Table 1. CB-300 model from Energy Sciences Inc. in Wilmington, Mass., and the Broadbeam EP Series model from PCT Engineered Systems, LLC in Davenport Iowa. The line speed was 20 to 30 ft/min (600-900 cm/min). The Release Liner 1 was removed before curing the silicone in the irradiation chamber. Release Liner 1 was reapplied by lamination after curing to keep the sample clean. The chamber was actively flushed with N₂ gas in order to lower the oxygen content inside the irradiation chamber (<50 ppm) during irradiation. The accelerating voltage of the electron beam used to cure the silicone was 220 kV. The radiation doses provided to cure the silicone were from 0.5 to 7 Mrad (5 to 70 kGy) as noted in Table 1. All Examples were tested for 90° Peel Adhesion and Self Wetting Speed as noted in Table 1.

TABLE 1
Example conditions and Peel and Self Wetting results.

| | | | | 90° Peel | | |
|---|---|---|---|---|---|---|
| | | | E-Beam | Adhesion, | 90° Peel | Self |
| | | Dry Coat | Chamber | Room | Adhesion, | Wetting |
| | Coating | Thickness | and Dose | Temp, 15 | 80° C., 72 | Speed |
| Example | Solution | (microns) | (Mrad) | min. (g/in) | hr. (g/in) | (sec) |
| 1 | 1 | 5 | CB 0.5 | 33.4 | 111.0 | 2.88 |
| 2 | 1 | 10 | CB 0.5 | 51.9 | 132.7 | 3.31 |
| 3 | 2 | 5 | CB 0.5 | 7.97 | 95.1 | 1.80 |
| 4 | 2 | 10 | CB 0.5 | 8.80 | 74.7 | 2.45 |
| 5 | 1 | 5 | CB 1.0 | 24.8 | 93.3 | 2.84 |
| 6 | 1 | 10 | CB 1.0 | 44.3 | 120 | 3.10 |
| 7 | 2 | 5 | CB 1.0 | 4.57 | 74.4 | 1.59 |
| 8 | 2 | 10 | CB 1.0 | 7.83 | 69.5 | 1.82 |
| 9 | 1 | 5 | EP 2.0 | 23.9 | 72.7 | 3.04 |
| 10 | 1 | 10 | EP 2.0 | 37.6 | 103.4 | 2.95 |
| 11 | 2 | 5 | EP 2.0 | 5.20 | 47.2 | 1.63 |
| 12 | 2 | 10 | EP 2.0 | 8.93 | 47.8 | 1.61 |
| 13 | 1 | 5 | EP 4.0 | 16.3 | 55.9 | 3.10 |
| 14 | 1 | 10 | EP 4.0 | 22.2 | 60.2 | 3.02 |
| 15 | 2 | 5 | EP 4.0 | 4.07 | 31.0 | 1.43 |
| 16 | 2 | 10 | EP 4.0 | 6.50 | 23.9 | 1.52 |
| 17 | 1 | 5 | EP 7.0 | 2.33 | 13.1 | 1.64 |
| 18 | 1 | 10 | EP 7.0 | 3.67 | 8.43 | 1.59 |
| 19 | 2 | 5 | EP 4.0 | 1.67 | 26.2 | 1.15 |
| 20 | 2 | 10 | EP 7.0 | 2.13 | 8.73 | 0.94 |

CB = CB-300 model from Energy Sciences Inc. in Wilmington, MA
EP = Broadbeam EP Series model from PCT Engineered Systems, LLC in Davenport Iowa

Examples 19, 14, and 18 were additionally tested for higher temperate 90° Peel Adhesion and Clean Removal Performance as shown in Table 2.

TABLE 2

| | Example | Example | Example |
|---|---|---|---|
| Test Conditions | 19 | 14 | 18 |
| 90° Peel Adhesion, | 472 | 69.2 | 8.15 |
| 80° C., 24 hr. (g/in) | | | |
| Clean Removal Performance | / | 5 | 5 |
| (80° C./24 h) | | | |
| 90° Peel Adhesion, | / | / | 3.63 |
| 140° C., 30 min. (g/in) | | | |
| Clean Removal Performance | / | / | 5 |
| (140° C./30 min) | | | |
| 90° Peel Adhesion, | / | / | 35.2 |
| 180° C., 30 min. (g/in) | | | |
| Clean Removal Performance | / | / | 5 |
| (180° C./30 min) | | | |

/ = not tested

### Examples 21, 22, 23—UVC Exposure

UVC (ultraviolet C radiation) was used to increase peel adhesion of samples of Example 18 material applied to a quartz glass surface. A 5 inch by ½ inch (13 cm×1.3 cm) sample of Example 18 was placed in contact with a 8 inch×2 inch×⅛ inch thick (20 cm×5.1 cm×0.32 cm) quartz glass plate (obtained from GM Associates 9824 Kitty Lane, Oakland Calif., as GE124) that was cleaned with isopropyl alcohol and allowed to air dry. The quartz glass was placed under a 15W germicidal lamp (available from Sankyo Denki G15T8 bi-pin) with an output of ˜3.8 mW/cm² as measured with a UV POWER PUCK II (available from EIT Inc., Sterling, Va., USA). The side of the glass with the applied sample was facing away from the lamp such that the UVC light passed through the glass, then through the sample and finally into the film. The samples were exposed to the lamp source for the times listed below in Table 3. After exposure the peel force was measured and reported below in Table 3.

TABLE 3
UVC Exposed Conditions and 90° Peel Adhesion Results

| | Time under | 90° Peel Adhesion, |
|---|---|---|
| | UVC source | Room Temp, 15 min. |
| Example | (mins) | (g/in) |
| 18 | 0 | 1.93 |
| 21 | 30 | 19.1 |
| 22 | 60 | 26.2 |
| 23 | 90 | 37.5 |

### Example 24 Primed Polyimide Film

### Coating and Drying Process:

The Solution 1 was coated on to Primed Film 2 with a slot die and heated in an oven to 70° C. to remove all the volatile solvent to give a final coating thickness of 10 micrometers. Release Liner 1 was laminated to the coated side. This created a silicone elastomer coating between a polyimide film and a release liner.

### E-Beam Process:

A commercially available electron beam unit was used to cure the silicone (Broadbeam EP Series model from PCT Engineered Systems, LLC in Davenport Iowa). The line speed was 20 to 30 ft/min (600-900 cm/min). The Release Liner 1 was removed before curing the silicone in the irradiation chamber. Release Liner 1 was reapplied by lamination after curing to keep the sample clean. The chamber was actively flushed with N₂ gas in order to lower the oxygen content inside the irradiation chamber (<50 ppm) during irradiation. The accelerating voltage of the electron beam used to cure the silicone was 220 kV. The radiation doses provided to cure the silicone was 7 Mrad (70 kGy) as noted in Table 4.

TABLE 4
Example 24 Conditions and 90° Peel Adhesion Results.

| | | | | 90° Peel | 90° Peel |
|---|---|---|---|---|---|
| | | | E-Beam | Adhesion, | Adhesion, |
| | | Dry Coat | Chamber | Room Temp, | 180° C., 30 |
| | Coating | Thickness | and Dose | 15 min. | minutes |
| Example | Solution | (microns) | (Mrad) | (g/in) | (g/in) |
| 24 | 1 | 10 | EP 7.0 | 1.9 | 97.3 |

1. A protective film article comprising:
a thermally stable tape backing with a first major surface and a second major surface;
a primer layer on the first major surface of the thermally stable tape backing;
and a self-wetting, tack-free adhesive layer at least partially coated on the primer layer,
wherein the tack-free adhesive layer comprises at least one siloxane-based elastomeric polymer that is unchanged after heat aging of 180° C. for 30 minutes, and is able to removably adhere to an optical or electronic device without leaving residue on the optical or electronic device.

2. The protective film article of claim 1, wherein the primer layer comprises a plasma-coated discontinuous silane-based primer.

3. The protective film article of claim 2, wherein the plasma-coated discontinuous silane-based primer layer comprises nanostructures.

4. The protective film article of claim 3, wherein the nanostructures comprise silanol-functional groups.

5. The protective film article of claim 1, wherein the at least one siloxane-based elastomeric polymer comprises a crosslinked polydiorganosiloxane polyurea copolymer or a crosslinked polydiorganosiloxane polyoxamide copolymer, wherein the crosslinked polydiorganosiloxane polyoxamide copolymer or crosslinked polydiorganosiloxane polyurea copolymer has a number average molecular weight of at least 40,000 grams/mole prior to crosslinking.

6. The protective film article of claim 1, wherein the at least one siloxane-based copolymer comprises a siloxane polyurea-based segmented copolymer comprising at least one repeat unit of the general structure I: 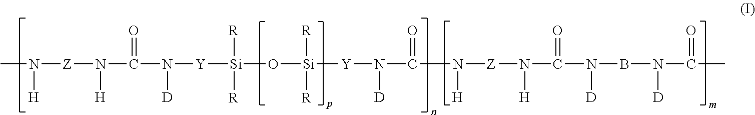
wherein
each R independently is an alkyl, substituted alkyl, cycloalkyl, aryl, or substituted aryl;
each Z is a polyvalent radical of an arylene, an aralkylene, an alkylene, or a cycloalkylene;
each Y is a polyvalent radical that independently is an alkylene, an aralkylene, or an arylene radical;
each D is selected from the group consisting of hydrogen, an alkyl radical, phenyl, and a radical that completes a ring structure including B or Y to form a heterocycle;
B is a polyvalent radical selected from the group consisting of alkylene, aralkylene, cycloalkylene, phenylene, and heteroalkylene;
m is a number that is 0 to about 1000;
n is a number that is at least 1; and
p is a number that is at least 10.

7. The protective film article of claim 1, wherein the at least one siloxane-based copolymer comprises a siloxane polyoxamide-based segmented copolymer comprising at least two repeat units of Formula II: 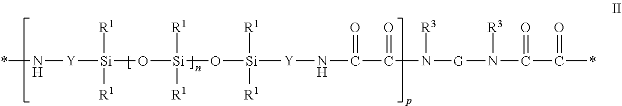
wherein
each R¹ is independently an alkyl, haloalkyl, aralkyl, alkenyl, aryl, or aryl substituted with an alkyl, alkoxy, or halo;
each Y is independently an alkylene, aralkylene, or a combination thereof;
n is independently an integer of 40 to 1500; and
p is an integer of 1 to 10;
G is a divalent group that is the residue unit that is equal to a diamine of formula R³HN-G-NHR³ minus the two —NHR³ groups, where R³ is hydrogen or alkyl, or R³ taken together with G and with the nitrogen to which they are both attached forms a heterocyclic group; and
each asterisk (*) indicates a site of attachment of the repeat unit to another group in the copolymer.

8. The protective film article of claim 1, wherein the self-wetting, tack-free adhesive layer further comprises at least one additive.

9. The protective film article of claim 8, wherein the additive comprises a tackifying resin, a non-migrating plasticizing agent, an antistatic agent, a particle, a dye, an optical filtering UV light absorber, a chromophore, or combinations thereof.

10. The protective film article of claim 9, wherein the tackifying resin comprises an MQ siloxane resin.

11. The protective film article of claim 1, wherein the protective film article is transparent to electromagnetic radiation of wavelengths of the infrared region, the visible region, the ultraviolet region, or a combination thereof.

12. A method of preparing an optical or electronic article comprising:
providing an optical or electronic construction wherein the optical or electronic construction comprises at least a first major surface and a second major surface;
providing a protective film article, the protective film article comprising:
a thermally stable tape backing with a first major surface and a second major surface;
a primer layer on the first major surface of the thermally stable tape backing; and
a self-wetting, tack-free adhesive layer at least partially coated on the primer layer, wherein the self-wetting tack-free adhesive layer comprises at least one siloxane-based elastomeric polymer that is unchanged after heat aging of 180° C. for 30 minutes, and is able to removably adhere to an optical or electronic device without leaving residue on the optical or electronic device;
adhering the tack-free adhesive layer of the protective film article to the second major surface of the optical or electronic construction to form a laminate;
subjecting the optical laminate to at least one processing step; and
cleanly removing the protective film article from the second major surface of the optical or electronic construction.

13. The method of claim 12, wherein the primer layer comprises a plasma-coated discontinuous silane-based primer.

14. The method of claim 13, wherein the plasma-coated discontinuous silane-based primer layer comprises nanostructures.

15. The method of claim 12, wherein the at least one siloxane-based elastomeric polymer comprises a crosslinked polydiorganosiloxane polyurea copolymer or a crosslinked polydiorganosiloxane polyoxamide copolymer, wherein the crosslinked polydiorganosiloxane polyoxamide copolymer or crosslinked polydiorganosiloxane polyurea copolymer has a number average molecular weight of at least 40,000 grams/mole prior to crosslinking.

16. The method of claim 12, wherein the at least one siloxane-based copolymer comprises a siloxane polyurea-based segmented copolymer comprising at least one repeat unit of the general structure I: 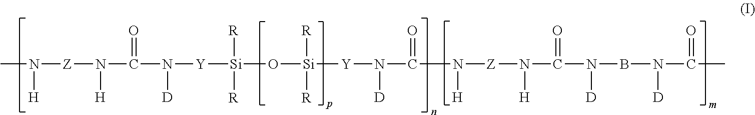
wherein
each R independently is an alkyl, substituted alkyl, cycloalkyl, aryl, or substituted aryl;
each Z is a polyvalent radical of an arylene, an aralkylene, an alkylene, or a cycloalkylene;
each Y is a polyvalent radical that independently is an alkylene, an aralkylene, or an arylene radical;
each D is selected from the group consisting of hydrogen, an alkyl radical, phenyl, and a radical that completes a ring structure including B or Y to form a heterocycle;
B is a polyvalent radical selected from the group consisting of alkylene, aralkylene, cycloalkylene, phenylene, and heteroalkylene;
m is a number that is 0 to about 1000;
n is a number that is at least 1; and
p is a number that is at least 10.

17. The method of claim 12, wherein the at least one siloxane-based copolymer comprises a siloxane polyoxamide-based segmented copolymer comprising at least two repeat units of Formula II: 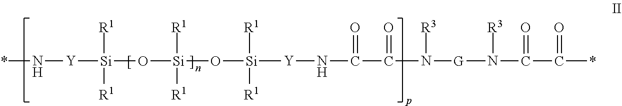
wherein
each R¹ is independently an alkyl, haloalkyl, aralkyl, alkenyl, aryl, or aryl substituted with an alkyl, alkoxy, or halo;
each Y is independently an alkylene, aralkylene, or a combination thereof;
n is independently an integer of 40 to 1500; and
p is an integer of 1 to 10;
G is a divalent group that is the residue unit that is equal to a diamine of formula R³HN-G-NHR³ minus the two —NHR³ groups, where R³ is hydrogen or alkyl, or R³ taken together with G and with the nitrogen to which they are both attached forms a heterocyclic group; and
each asterisk (*) indicates a site of attachment of the repeat unit to another group in the copolymer.

18. The method of claim 12, wherein the self-wetting, tack-free adhesive layer further comprises at least one additive comprising a tackifying resin, a non-migrating plasticizing agent, an antistatic agent, a particle, a dye, an optical filtering UV light absorber, a chromophore, or combinations thereof.

19. The method of claim 18, wherein the tackifying resin comprises an MQ siloxane resin.

20. The method of claim 12, wherein the protective film article is transparent to electromagnetic radiation of wavelengths of the infrared region, the visible region, the ultraviolet region, or a combination thereof.

21. The method of claim 12, wherein the protective film article is optically transparent to electromagnetic radiation of wavelengths of the visible region.

22. The method of claim 12, wherein the at least one processing step comprises at least one of heat aging at 180° C. for 30 minutes, transportation of the optical or electronic article, application of pressure or mechanical force, or exposure to radiation.

23. The method of claim 15, further comprising exposing the crosslinked polydiorganosiloxane polyoxamide copolymer, to UV radiation at or below the B spectral range to decrease the level of crosslinking in the crosslinked polydiorganosiloxane polyoxamide copolymer.
